(19) United States
(12) Patent Application Publication
(10) Pub. No.: US 2024/0075555 A1
(43) Pub. Date: Mar. 7, 2024

(54) LASER WELDING METHOD

(71) Applicant: FUJI ELECTRIC CO., LTD., Kanagawa (JP)

(72) Inventor: Yuta KOGURE, Matsumoto-city (JP)

(21) Appl. No.: 18/356,245

(22) Filed: Jul. 21, 2023

(30) Foreign Application Priority Data
Sep. 1, 2022 (JP) 2022-139087

(51) Int. Cl. B23K 26/244; B23K 26/323

(52) U.S. Cl. CPC B23K 26/244; B23K 26/323; B23K 2103/12

(57) ABSTRACT

Provide is a laser welding method of a lamination member including a second base material provided on a first base material, the laser welding method including forming a first scanning route by scanning a laser from a first point of the lamination member to a second point different from the first point, the first point being predetermined, and forming a second scanning route, at least a portion of which is shared with the first scanning route, by scanning the laser from a third point of the lamination member to a fourth point different from the third point, the third point being predetermined, and melting the first base material and the second base material in a common region between the first scanning route and the second scanning route, in which a welding depth of the first base material is 0.2 mm or more and 0.7 mm or less.

The contents of the following patent application(s) are incorporated herein by reference:
NO. 2022-139087 filed in JP on Sep. 1, 2022

### TECHNICAL FIELD

The present invention relates to a laser welding method.

### BACKGROUND

Patent document 1 describes a laser welding method “characterized in providing a space by a predetermined distance such that a laser beam is not applied on a molten pool formed in the first step, and a laser beam is applied before the molten pool formed in the first step is solidified”.

### PRIOR ART DOCUMENT

### Patent Document

Patent Document 1: Japanese Patent Application Publication No. 2020-15053
Patent Document 2: Japanese Patent Application Publication No. 2017-164811
Patent Document 3: Japanese Patent Application Publication No. 2021-53685
Patent Document 4: Japanese Patent Application Publication No. 2012-178600

### BRIEF DESCRIPTION OF THE DRAWINGS

FIG. 1 is a schematic view when bonding two base materials by laser welding.

FIG. 2 is a schematic view representing a scanning route when scanning a laser.

FIG. 3A is a diagram representing a relationship between an amount of occurrence of sputtering and a scanning speed.

FIG. 3B is a diagram representing an appearance of a cross section in a comparative example.

FIG. 3C is a diagram representing an appearance of a cross section in an embodiment.

FIG. 4 is a schematic view of a cross section when scanning the laser.

FIG. 5A is an example when applying the laser for a plurality of times.

FIG. 5B is an example when applying the laser for the plurality of times.

FIG. 5C is an example when applying the laser for the plurality of times.

FIG. 5D is an example when applying the laser for the plurality of times.

FIG. 5E is an example when applying the laser for the plurality of times.

FIG. 6A is a diagram representing an appearance of a surface after applying the laser for the plurality of times.

FIG. 6B is a diagram representing an appearance of a bonded surface after applying the laser for the plurality of times.

FIG. 6C is a diagram representing an appearance of a cross section after applying the laser for the plurality of times.

FIG. 7 is a diagram representing a relationship between a welding depth and a tensile shear strength.

FIG. 8 is a diagram representing relationships among an input heat quantity, a scanning speed, and a welding depth.

FIG. 9 is a diagram representing a relationship between a bonded area and a tensile shear strength.

FIG. 10 is a diagram representing a relationship between a scanning speed and a bonded area.

### DESCRIPTION OF EXEMPLARY EMBODIMENTS

Hereinafter, embodiments of the present invention will be described, but the embodiments do not limit the invention according to the claims. In addition, not all of the combinations of features described in the embodiments are essential to the solution of the invention.

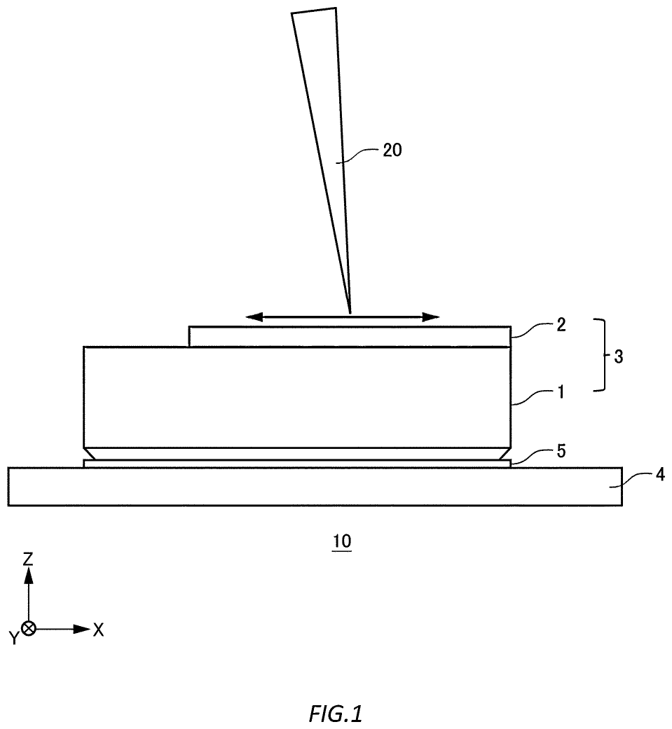

FIG. 1 is a schematic view when manufacturing a semiconductor module 10 by bonding two base materials by laser welding. The semiconductor module 10 includes a lamination member 3, an insulating substrate 4, and a solder 5 which adheres the lamination member 3 and the insulating substrate 4.

The lamination member 3 may include a first base material 1 and a second base material 2 provided on the first base material. In FIG. 1, by applying a laser 20 from above the lamination member 3 and scanning the laser 20 as represented by an arrow, both the first base material 1 and the second base material 2 are melted, and the lower surface of the first base material 1 and the upper surface of the second base material 2 are each welded.

As an example, the first base material 1 and the second base material 2 may include at least one of copper, nickel, aluminum, or iron. As an example, the first base material 1 may be pure copper, and the second base material 2 may be obtained by performing nickel plating on a surface of a base material including copper.

The second base material 2 may be thinner than the first base material 1. As an example, a thickness of the second base material 2 may be one-third or less, one-quarter or less, or one-fifth or less of a thickness of the first base material 1. As an example, the thickness of the second base material 2 may be 0.8 mm, and the thickness of the first base material 1 may be 2.4 mm.

The laser 20 may be applied from a fiber laser, or may be applied from a carbon dioxide laser. As an example, the laser 20 may be an IR laser, and a wavelength of the laser 20 may be 1.05 μm or more and may be 1.10 μm or less. As an example, the laser 20 may be a green laser, and the wavelength of the laser 20 may be 500 nm.

An output of the laser 20 may be a value that allows generation of at least a keyhole between the first base material 1 and the second base material 2. The keyhole is a hole that is generated as a result of the first base material 1 and the second base material 2 being vaporized by application of the laser 20 on the lamination member 3, and a molten pool becoming a concave shape due to vapor pressure. As an example, the output of the laser 20 may be 2850 W or more and may be 3300 W or less. As an example, the output of the laser 20 may be constant during scanning of the laser 20.

The present specification describes the case of key-hole welding as an example, but the present invention is not limited thereto. That is, the welding may be performed with other manners such as heat-conduction type welding.

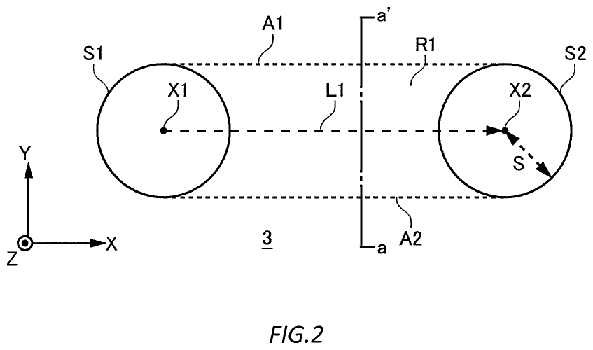

FIG. 2 is a top view when performing scanning while applying the laser 20 from above the lamination member 3. As shown in FIG. 2, while applying the laser 20 from above the lamination member 3, the laser 20 may be scanned along a first trajectory L1 at a scanning speed V such that an aim of the laser 20 moves from a first point X1 to a second point X2. A distance between the first point X1 and the second point X2 may be 2.85 mm or more and may be 3.10 mm or less.

A first scanning route R1 is a region through which an application range passes when the laser 20 is scanned from the first point X1 to the second point X2. A line segment A1 is an upper end of the first scanning route R1, and a line segment A2 is a lower end thereof. The first scanning route R1 is a region surrounded by the line segments A1, A2 and application ranges S1, S2.

The application range S1 is an application range when the aim of the laser 20 is at the point X1. The application range S2 is an application range when the aim of the laser 20 is at the point X2. An application diameter S is a radius of an application range.

The application diameter S may be constant during the scanning of the laser 20. As an example, the application diameter S may be 0.20 mm or more, or may be 0.21 mm or less.

The scanning speed V is a speed of the laser 20 in a scanning direction. The scanning speed V may be constant, or may be changed, during the scanning of the laser 20. A preferable value of the scanning speed V will be described later.

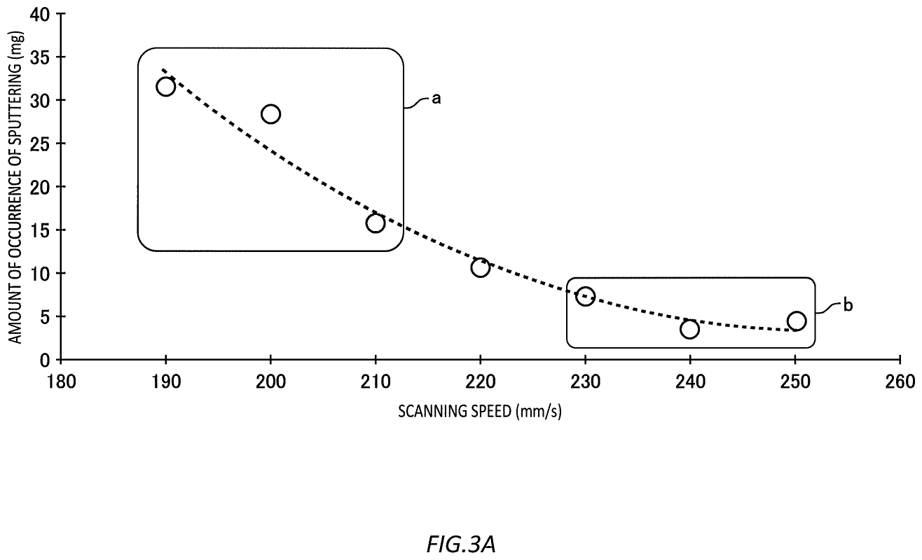

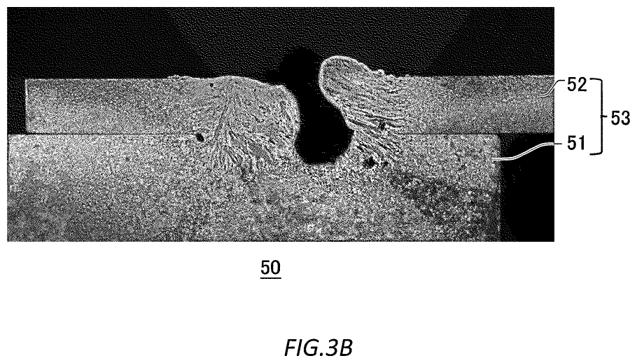

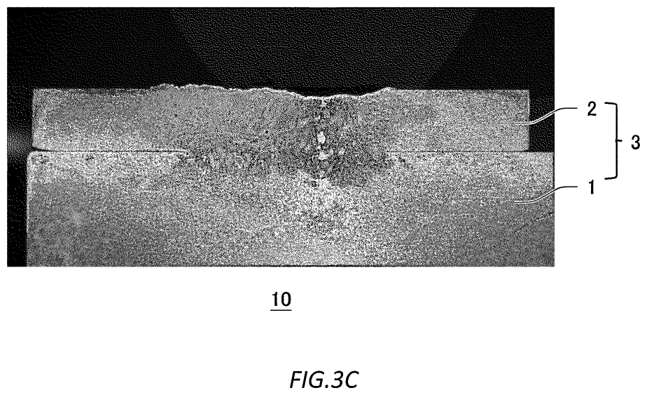

FIG. 3A is a graph representing the scanning speed V of the laser 20 and an amount of occurrence of sputtering. As the scanning speed V becomes larger, a welding depth d to be described later will become shallow, and occurrence of sputtering and blowholes will be reduced. A blowhole is a phenomenon in which air entered into a keyhole is expanded due to heating, and a hollow space is generated inside a welding portion. In addition, sputtering is a phenomenon in which molten metal scatters due to burst of a blowhole or the like.

A range denoted by a in FIG. 3A is a scanning speed in a comparative example. In the range denoted by a in FIG. 3A, the amount of occurrence of sputtering is 10 mg or more. As will be shown in FIG. 3B later, it is recognized that sputtering and blowholes are frequently occurring in a level that allows conformation with bare eyes in the comparative example.

In addition, a range denoted by b in FIG. 3A is a scanning speed in the present embodiment. In the range denoted by b in FIG. 3A, the amount of occurrence of sputtering is reduced to 10 mg or less. As will be shown in FIG. 3C later, in the present embodiment, occurrence of sputtering and blowholes is reduced to a level that these cannot be confirmed with bare eyes.

In the present embodiment, by setting the scanning speed V to a predetermined value, the amount of occurrence of sputtering and blowholes can be reduced also when the output during the scanning of the laser 20 is made constant. As an example, the scanning speed V may be 220 mm/s or more and may be 260 mm/s or less.

FIG. 3B is a diagram representing a cross-sectional view after scanning in the comparative example. The cross-sectional view is that of a semiconductor module 50 in the comparative example, after scanning the laser 20 from above a lamination member 53 including a first base material 51 and a second base material 52 provided on the first base material 51 such that the scanning speed V becomes 190 mm/s.

As is apparent from FIG. 3B, in the comparative example, a blowhole has occurred inside the first base material 51, and sputtering has occurred on the upper surface of the second base material 52.

On the other hand, FIG. 3C is a diagram representing a cross-sectional view after scanning in the present embodiment. The cross-sectional view is that of the semiconductor module 10 in the embodiment, after scanning the laser 20 from above the lamination member 3 including the first base material 1 and the second base material 2 provided on the first base material 1 such that the scanning speed V becomes 230 mm/s.

As is apparent from FIG. 3C, it is recognized that there is almost no occurrence of blowholes and sputtering in the present embodiment.

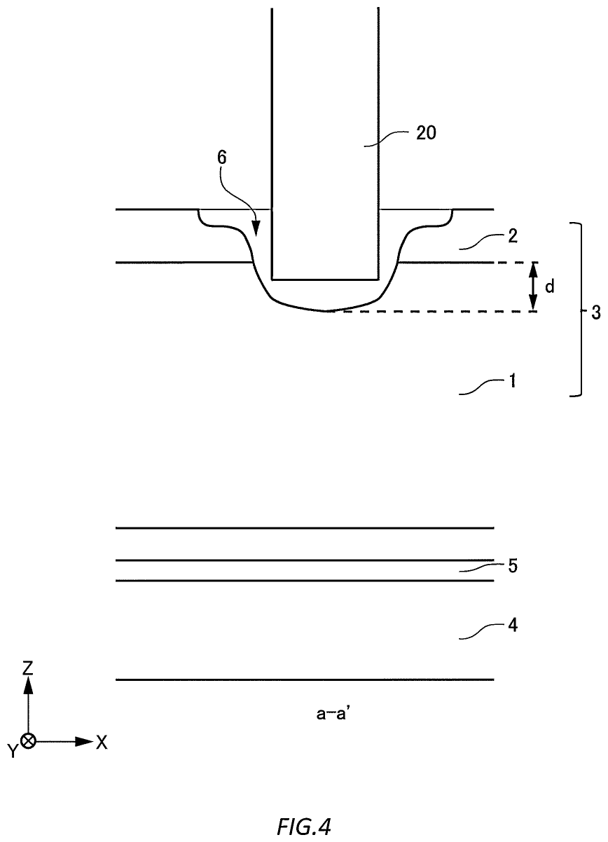

FIG. 4 is a cross-sectional view along a line a-a′ in FIG. 2 when the laser 20 is applied on the line a-a′. With the laser 20 being applied, both the first base material 1 and the second base material 2 are melted. A molten pool 6 is a region made of molten metal that is formed by melting of the first base material 1 and the second base material 2.

The welding depth d is a depth of the molten pool 6 measured from the upper surface of the first base material 1. When the bottom surface of the molten pool 6 is uneven, the welding depth d may be the depth of the lower end of the molten pool 6 measured from the upper surface of the first base material 1. The welding depth d may be the depth at the deepest position of the molten pool 6. In addition, the welding depth d may be the depth at a peak position of the depth of the molten pool 6.

Since the scanning speed V of the present embodiment is faster than a scanning speed at the time of single-time scanning of the laser 20, the welding depth d becomes shallower than that of the single-time scanning. The welding depth d may be 1.0 mm or less. As an example, the welding depth d may be 0.2 mm or more and may be 0.7 mm or less.

There is a concern that, with the welding depth d becoming shallower, a strength of a welding portion will be degraded. In the present embodiment, a desired welding strength can be achieved by scanning the laser 20 for a plurality of times.

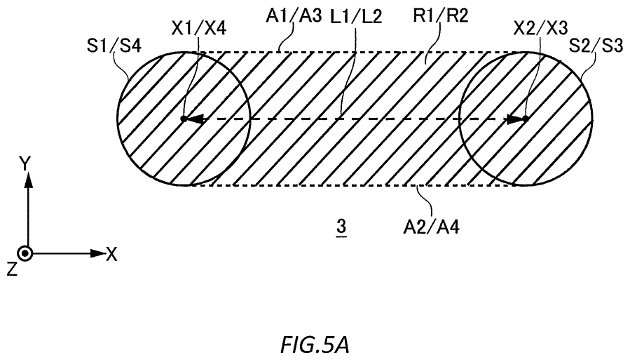

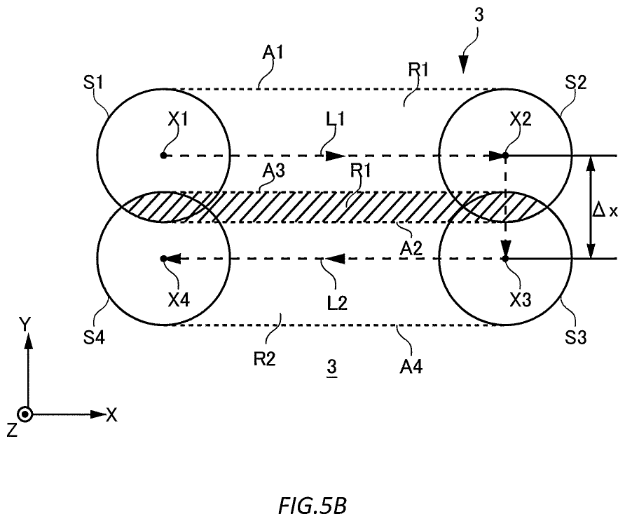

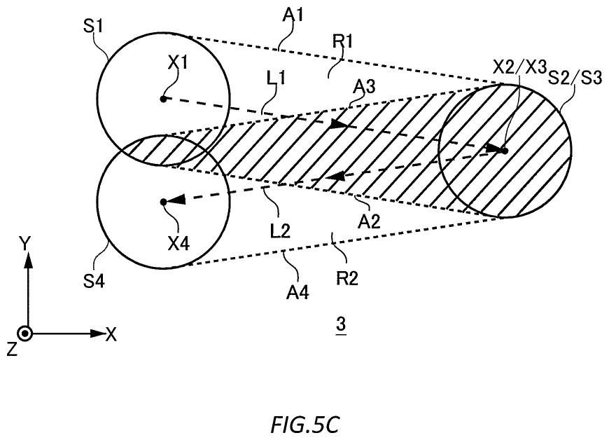

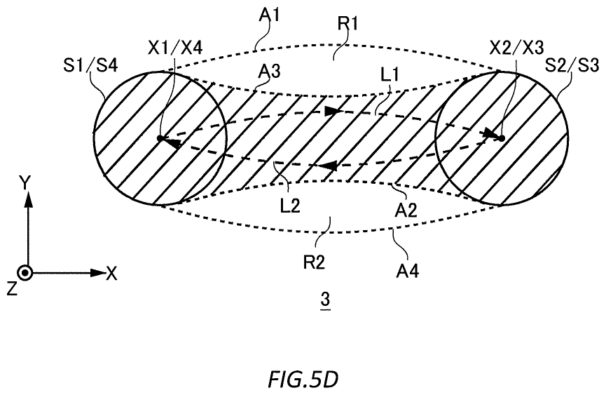

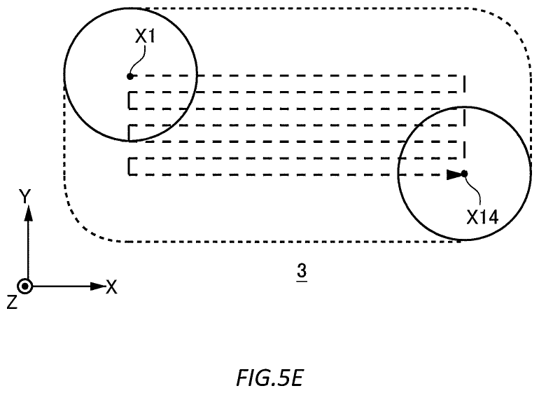

FIG. 5A is a top view when scanning the laser 20 for a plurality of times. In FIG. 5A, after forming the first scanning route R1, the laser 20 is further scanned at the scanning speed V along a second trajectory L2 such that the aim of the laser 20 moves from a third point X3 to a fourth point X4.

A second scanning route R2 is a region through which an application range passes when the laser 20 is further scanned from the third point X3 to the fourth point X4. A line segment A3 is the upper end of the second scanning route R2, and a line segment A4 is the lower end thereof. The second scanning route R2 is a region surrounded by the line segments A3, A4 and application ranges S3, S4.

The application range S3 is an application range when the aim of the laser 20 is at the point X3. In addition, the application range S4 is an application range when the aim of the laser 20 is at the point X4.

A region surrounded by the application ranges S1 to S4 and the line segments A2, A3 is a common region between the first scanning route R1 and the second scanning route R2. Since the laser 20 is applied more than twice to the common region in the process of scanning for the plurality of times, the welding depth d becomes deeper than other points on the scanning routes. That is, by providing the common region, an improved welding strength can be achieved.

The third point X3 may be the second point X2, and the fourth point X4 may be the first point X1. In addition, the second trajectory L2 may be the first trajectory L1. That is, as an example, the laser 20 may be scanned for the plurality of times in a manner that causes reciprocation on the first scanning route R1. By causing reciprocation in a same scanning route, the welding depth d can be deepened, and an improved welding strength can be achieved.

FIG. 5B is an example when scanning the laser 20 for the plurality of times. In the example of FIG. 5B, first, the laser 20 is scanned at the scanning speed V along the first trajectory L1 such that the aim of the laser 20 moves from the first point X1 to the second point X2. Then, the aim of the laser 20 is moved to the point X3, which is distant from the point X2 by a predetermined application position shifting amount Δx. In the embodiment of FIG. 5B, the laser 20 is not applied when moving the aim from the point X2 to the point X3, but the laser 20 may be applied at this time.

The laser 20 is subsequently scanned at the scanning speed V along the second trajectory L2 such that the aim of the laser 20 moves from the third point X3 to the fourth point X4. The region surrounded by the application ranges S1 to S4 and the line segments A2, A3 shown with oblique lines in FIG. 5B is the common region between the first scanning route R1 and the second scanning route R2. In the common region, the laser is applied when the laser 20 is scanned from the points X1 to X2 and also when scanned from the points X3 to X4.

The application position shifting amount Δx may be any value that allows the first scanning route R1 and the second scanning route R2 to have the common region. In addition, the application position shifting amount Δx may be less than twice of the application diameter S. As an example, Δx may be larger than 0, and may be 0.20 mm or less.

FIG. 5C is an example when scanning the laser 20 for the plurality of times. In FIG. 5C, the third point X3 may be the second point X2. In addition, the application range S2 and the application range S3 may be the same. That is, a step of moving the aim of the laser 20 to a point different from the point X2 may not be provided. Also in this case, the definitions of the first scanning route R1, the second scanning route R2, and the common region are the same as those in FIG. 5A.

FIG. 5D is an example when scanning the laser 20 for the plurality of times. In FIG. 5D, the third point X3 may be the second point X2, and the fourth point X4 may be the first point X1. That is, as an example, the laser 20 may be scanned for the plurality of times in a manner that causes reciprocation between two different points.

In FIG. 5D, the first trajectory L1 drawn by the center of the laser 20 when forming the first scanning route R1 may be a curve. Similarly, the second trajectory L2 drawn by the center of the laser 20 when forming the second scanning route R2 may also be a curve. In addition, the first trajectory L1 and the second trajectory L2 may be different trajectories.

In a further embodiment, after the laser 20 is scanned to the point X4, a step of further scanning the laser 20 may be provided. That is, a step of forming a scanning route may be provided three times or more. The number of times of scanning the laser 20 may be five times or more, and may be seven times or less. The laser 20 may be scanned in a manner that causes reciprocation between two different points for a plurality of times.

FIG. 5E is an example when scanning the laser 20 for the plurality of times. FIG. 5E represents an embodiment of performing scanning while shifting the aim by the application position shifting amount Δx, as in the case shown in FIG. 58. In FIG. 5E, the laser 20 is scanned for seven times in total from the point X1 to a fourteenth point X14.

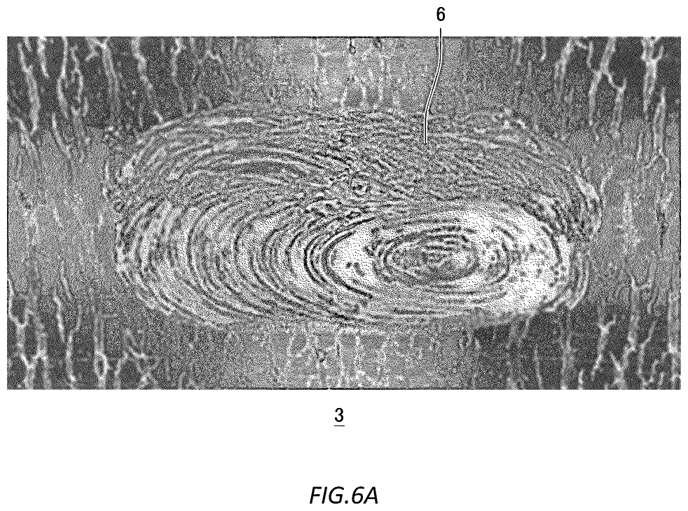

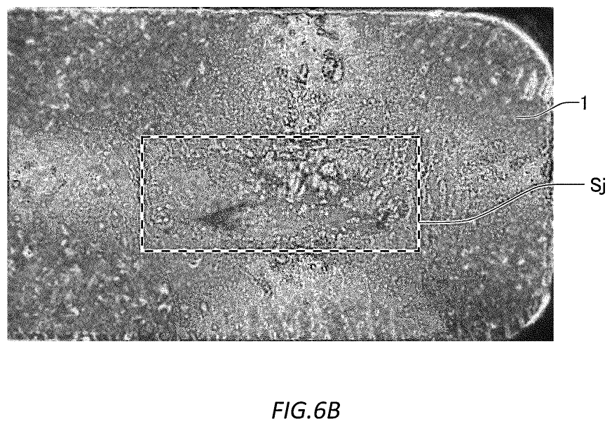

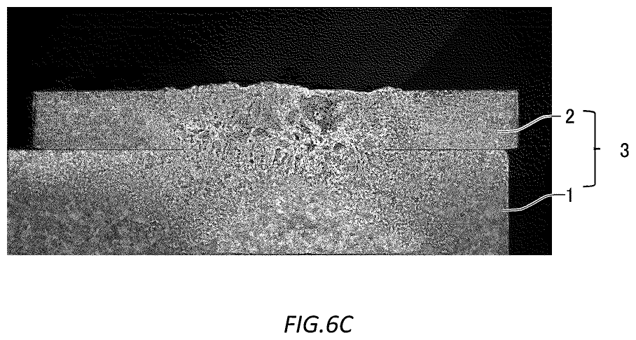

FIG. 6A is a diagram representing an appearance of a surface after applying the laser 20 for the plurality of times as in FIG. 5E. FIG. 6A shows, when denoting the output of the laser as W, the scanning speed as V, the application diameter as S, and the number of applications as n, the appearance of the surface at the time of W=3000 W, V=230 mm/s, S=0.2 mm, and n=7.

FIG. 6B is an example of a top view showing a bonded surface Sj. FIG. 6B represents, after the first base material 1 and the second base material 2 are welded under the condition of FIG. 6A, a state of the upper surface of the first base material 1 when the second base material 2 has been removed. The bonded surface Sj may be a surface of the molten pool 6 on the same plane surface as the upper surface of the first base material 1, and a bonded area may be an area of the molten pool 6 on the upper surface of the first base material 1. As shown in FIG. 6B, the bonded surface Sj is substantially a rectangle shape.

In general, the welding strength of a bonded portion increases as the bonded area of the bonded surface Sj becomes larger. As an example, a length of the short side of the bonded surface Sj in a direction perpendicular to a scanning direction of the laser 20 may be larger than the application diameter S of the laser 20. As an example, the length of the short side of the bonded surface may be 0.2 mm or more, and may be 0.6 mm or less.

FIG. 6C is a cross-sectional view of the lamination member 3 in the embodiment of FIG. 6A. As is apparent from FIG. 6C, in the present embodiment, it is recognized that there is almost no occurrence of blowholes and sputtering even when the laser 20 is scanned for the plurality of times.

As has been described above, in the present embodiment, by making the scanning speed V larger than that in the single-time scanning, occurrence of sputtering, blowholes, or the like can be reduced even when the laser 20 is scanned at an output that causes melting of both the first base material 1 and the second base material 2. In addition, although there is a concern that the welding depth d becomes shallower than that in the single-time scanning due to an increase in the scanning speed V and the bonding strength will be degraded, by scanning the laser 20 for the plurality of times, a desired bonding strength can be achieved by adjusting the welding depth d and the bonded area. The following describes a relationship between the scanning speed V and the bonding strength in details.

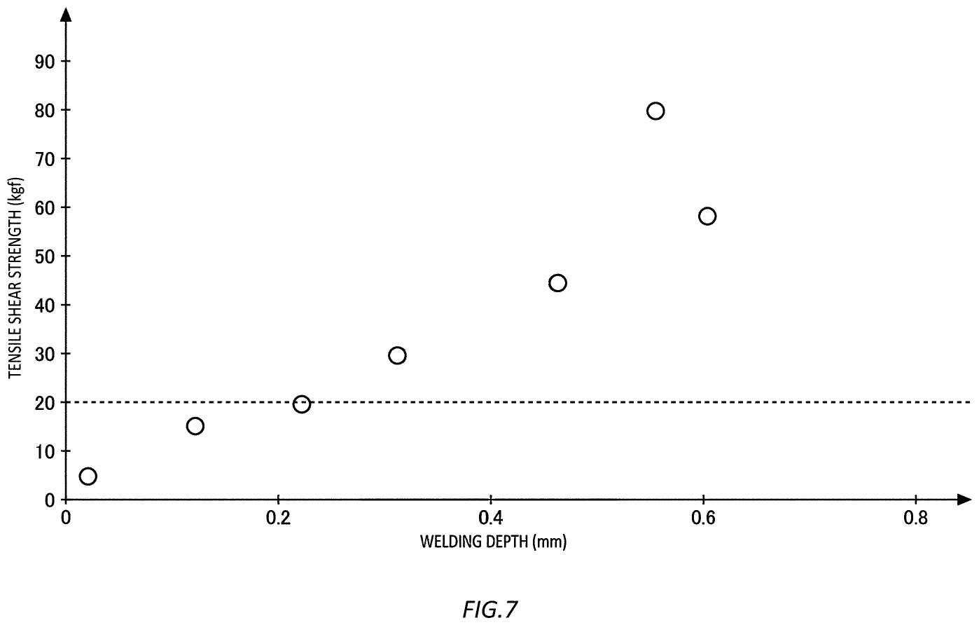

FIG. 7 is a diagram representing a relationship between the welding depth d and a tensile shear strength of a welding portion. From FIG. 7, it is recognized that the tensile shear strength increases as the welding depth d becomes larger. As an example, the tensile shear strength may be 20 kgf or more. The welding depth d may be 0.2 mm or more, and may be 0.7 mm or less.

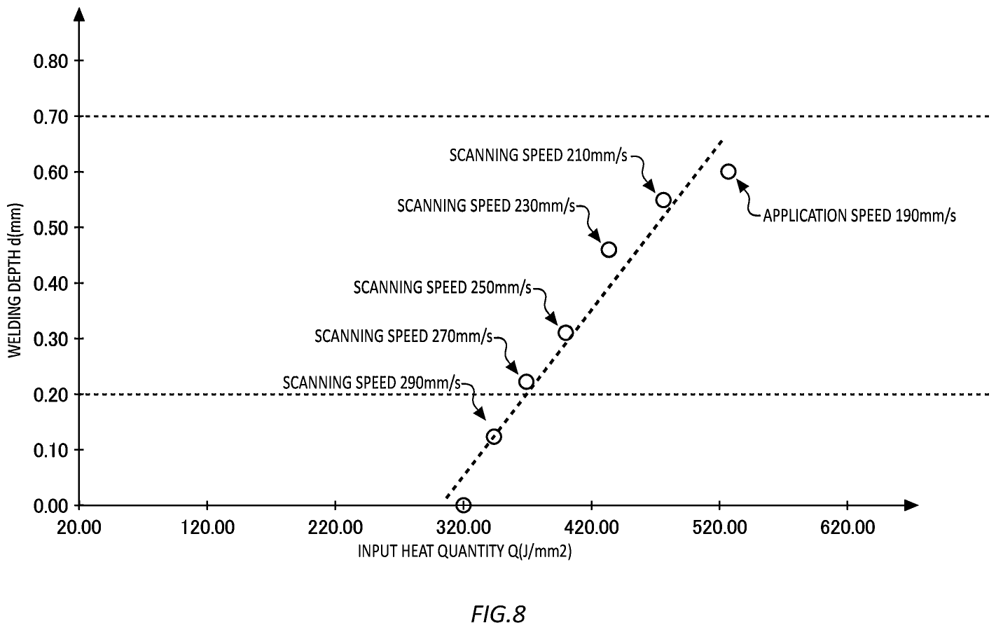

FIG. 8 is a diagram showing relationships among an input heat quantity Q per unit area of heat input to the first base material 1, a scanning speed of the laser 20, and the welding depth d. When denoting the output of the laser as W, the scanning speed as V, the application diameter as S, and the number of applications as n, the input heat quantity Q is represented by Q=nW/VS. That is, when the output W, the application diameter S, and the number of applications n are constant, the input heat quantity Q is a function of the scanning speed V. FIG. 7 shows, as an example, the case when W=3000 W, S=0.2 mm, and n=7.

When the input heat quantity Q is too large, the welding depth d may become too deep, and the solder 5 which bonds the first base material 1 and the insulating substrate 4 may be melted. As an example, the input heat quantity Q may be 380 J/mm² or more, and may be 460 J/mm² or less. In addition, the scanning speed V may be 220 mm/s or more, and may be 260 mm/s or less.

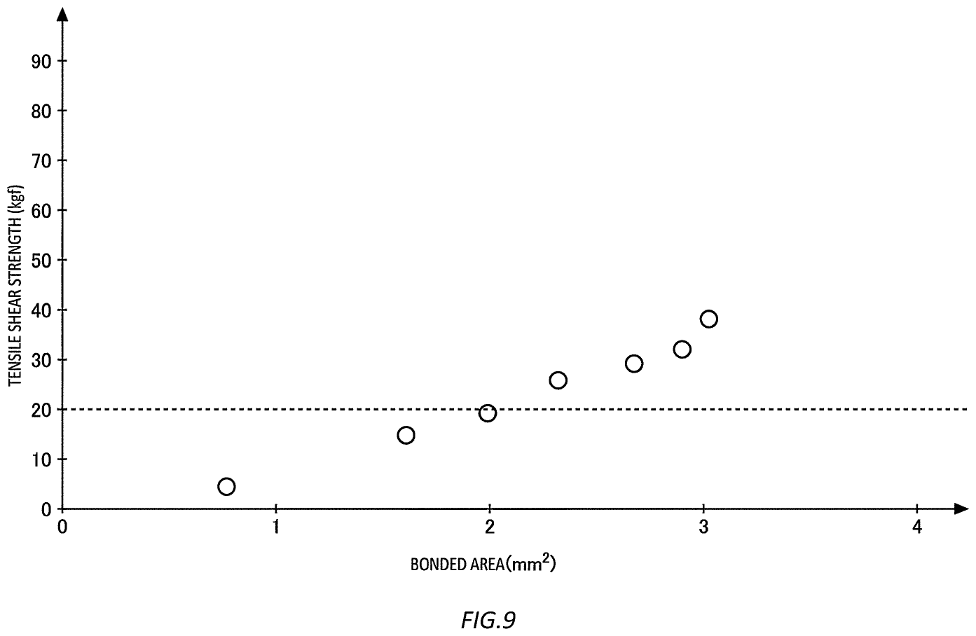

FIG. 9 is a diagram representing a relationship between a bonded area and a tensile shear strength of a welding portion. From FIG. 9, it is recognized that the tensile shear strength increases as the bonded area becomes larger. As an example, the bonded area may be 2.0 mm² or more, and may be 3.5 mm² or less.

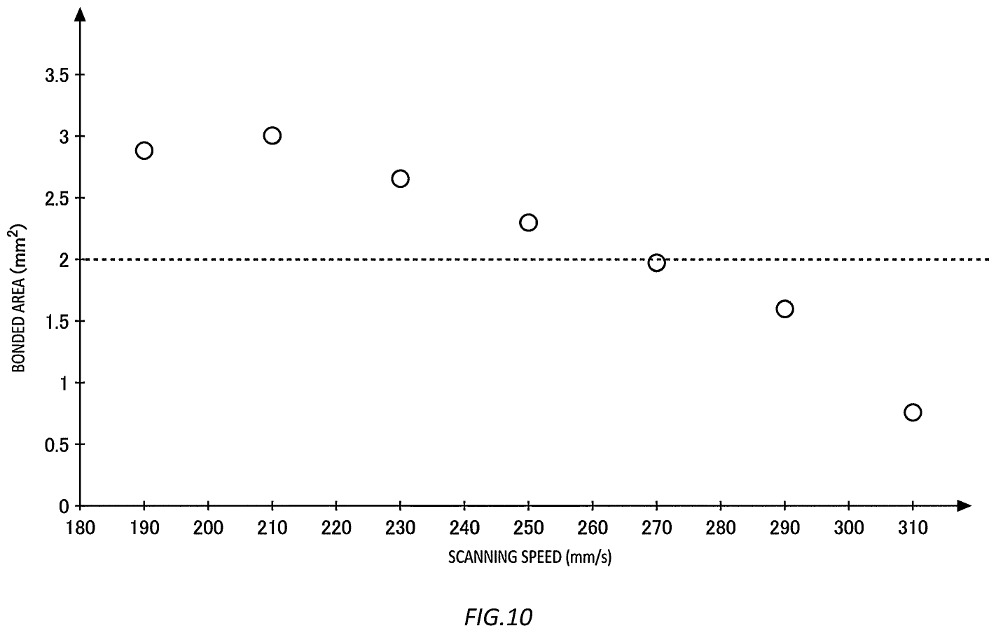

FIG. 10 is a diagram representing a relationship between a scanning speed and a bonded area. From FIG. 10, it is recognized that the bonded area decreases as the scanning speed V becomes larger. As an example, the scanning speed V may be 190 mm/s or more, and may be 270 mm/s or less.

While the present invention has been described by way of the embodiments, the technical scope of the present invention is not limited to the above-described embodiments. It is apparent to persons skilled in the art that various alterations or improvements can be made to the above-described embodiments. It is also apparent from the description of the claims that the embodiments to which such alterations or improvements are made can be included in the technical scope of the present invention.

The operations, procedures, steps, and stages of each process performed by an apparatus, system, program, and method shown in the claims, specification, or drawings can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

1, 51: first base material;
2, 52: second base material;
3, 53: lamination member;
4: insulating substrate;
5: solder;
6: molten pool;
10, 50: semiconductor module;
20: laser;
A1, A2, A3, A4: line segment;
d: welding depth;
L1: first trajectory;
L2: second trajectory;
n: number of applications;
Q; input heat quantity;
R1; first scanning route;
R2; second scanning route;
S: application diameter;
Sj: bonded surface;
S1, S2, S3, S4: application range;
V: scanning speed;
W: output;
X1: first point;
X2: second point;
X3: third point;
X4: fourth point;
X14: fourteenth point;
Δx: application position shifting amount.

What is claimed is:

1. A laser welding method of a lamination member comprising a second base material provided on a first base material, the laser welding method comprising:
forming a first scanning route by scanning a laser from a first point of the lamination member to a second point different from the first point, the first point being predetermined;
forming a second scanning route, at least a portion of which is shared with the first scanning route, by scanning the laser from a third point of the lamination member to a fourth point different from the third point, the third point being predetermined, and melting the first base material and the second base material in a common region between the first scanning route and the second scanning route, wherein
a welding depth of the first base material is 0.2 mm or more and 0.7 mm or less.

2. The laser welding method according to claim 1, wherein
the laser welding method is key-hole welding.

3. The laser welding method according to claim 1, wherein
the laser is applied from a fiber laser, and a wavelength of the laser is 1.05 μm or more and 1.1 μm or less.

4. The laser welding method according to claim 1, wherein
an input heat quantity that is input to the first base material by the laser applied on the first base material is 380 J/mm² or more and 460 J/mm² or less.

5. The laser welding method according to claim 1, wherein
a scanning speed of the laser is 220 mm/s or more and 260 mm/s or less.

6. The laser welding method according to claim 1, wherein
in a bonded surface of the first base material, a length of a short side in a direction perpendicular to a scanning direction of the laser is larger than an application diameter of the laser.

7. The laser welding method according to claim 1, wherein,
in an upper surface of the first base material, an area of a bonded surface of the first base material and the second base material is 2.0 mm² or more and 3.5 mm² or less.

8. The laser welding method according to claim 1, wherein
an application diameter of the laser is 0.20 mm or more and 0.21 mm or less.

9. The laser welding method according to claim 1, wherein
the third point is the second point, and the fourth point is the first point, and
the laser welding method comprises applying the laser while reciprocating between the first point and the second point of the lamination member.

10. The laser welding method according to claim 9, wherein
the applying the laser while reciprocating comprises reciprocating in the first scanning route.

11. The laser welding method according to claim 1, wherein
a distance between the first point and the second point is 2.85 mm or more and 3.10 mm or less.

12. The laser welding method according to claim 9, wherein
a number of reciprocation between the first point and the second point is five times or more and seven times or less.

13. The laser welding method according to claim 9, comprising reciprocating between the first point and the second point such that a first trajectory drawn by a center of an application range of the laser when scanning the laser from the first point to the second point and a second trajectory drawn by a center of an application range of the laser when scanning the laser from the second point to the first point become different trajectories.

14. The laser welding method according to claim 1, wherein
the first scanning route and the second scanning route are spaced apart from each other by a predetermined application position shifting amount.

15. The laser welding method according to claim 14, wherein
the application position shifting amount is larger than 0 and is 0.20 mm or less.

16. The laser welding method according to claim 1, wherein
the first base material comprises copper, and the second base material comprises copper and nickel.

17. The laser welding method according to claim 1, wherein
the forming the first scanning route comprises applying the laser at a constant output.

18. A laser welding apparatus which implements the laser welding method according to claim 1.

19. A laser welding apparatus which implements the laser welding method according to claim 2.

20. A laser welding apparatus which implements the laser welding method according to claim 3.
